(19) United States
(12) Patent Application Publication
(10) Pub. No.: US 2015/0290588 A1
(43) Pub. Date: Oct. 15, 2015

(54) SIGNAL RESPONSIVE SOLUTES

(71) Applicant: Robert MCGINNIS, (US)

(72) Inventor: Robert McGinnis, New York, NY (US)

(21) Appl. No.: 14/648,975

(22) PCT Filed: Dec. 4, 2013
(86) PCT No.: PCT/US13/72971

§ 371 Date: Jun. 2, 2015

Related U.S. Application Data
(60) Provisional application No. 61/733,115, filed on Dec. 4, 2012.

(51) Int. Cl. B01D 61/04; B01D 61/12; B01D 61/54; B01D 61/00

(52) U.S. Cl. CPC B01D 61/04; B01D 61/002; B01D 61/12; B01D 61/54

(57) ABSTRACT

Embodiment methods and systems for controlling the solubility of solutes in a membrane separation process are provided. Controlling solubility includes introducing a signal input to at least one solution used in the membrane separation process, such that the signal input changes the solubility of at least one solute in the at least one solution. Introducing the signal input is selected from the group of applying electromagnetic radiation to the at least one solution, applying mechanical input to the at least one solution, applying vibratory input to the at least one solution, changing a magnetic field of the at least one solution, introducing a secondary solute to the at least one solution, and removing a substance from the at least one solution.

### RELATED APPLICATIONS

This patent application claims the benefit of priority to U.S. Provisional Patent Application Ser. No. 61/733,115, entitled “Signal responsive solutes” filed on Dec. 4, 2012, the entire contents of which are hereby incorporated by reference.

### FIELD OF THE INVENTION

The present invention relates generally to the use of signal inputs to a solution to control solubility of solutes therein, and more particularly to recycle and re-concentrate draw solutions in a desalination process.

### BACKGROUND

Membrane separation techniques, such as osmotically drive membrane processes (ODMPs), have progressed rapidly in recent years for various desalination systems.

In some types of ODMPs, such as forward osmosis (FO) and direct osmotic concentration (DOC), a semi-permeable membrane between a feed solution and a solution containing recyclable solutes (i.e., a draw solution) creates osmotic pressure for the separation of the solvent and solute in the feed solution. The membrane system is then coupled to a draw solution solute recovery and re-concentration means to produce water substantially free of the feed solutes. In this manner, a change in concentration of solutes is transformed into separation work for water treatment (in FO system) or concentration of a feed solute (in DOC system). In another type of ODMP, pressure retarded osmosis (PRO), a low-salinity, unpressurized feed solution is drawn through a semi-permeable membrane into a pressurized, high-salinity draw solution, thereby expanding the volume of the draw solution. Power can be generated by releasing the pressure in the draw solution through a turbine. In this manner, a change in concentration of solutes is transformed into work, and thereby into electrical power. solutes are allowed to flow across ion selective membranes from a concentrated solution to a dilute solution. The flow of ions is captured as a current between a cathode and anode in the system to generate electricity. In this manner, a RED system transforms a change in concentration of solutes into electrical power.

In the various membrane separation systems, including ODMP and RED, the draw solutions may include solutes that are able to be re-concentrated by systems such as reverse osmosis (RO), as well as solutes that can be thermally stripped from solution, can be separated by application of a magnetic field, can be separated by the addition of acids or bases, or recycled by biological means.

### SUMMARY

The various embodiments provide methods of controlling the solubility of solutes in a membrane separation process, including introducing a signal input to at least one solution used in the membrane separation process, in which the signal input changes the solubility of at least one solute in the at least one solution, in which introducing the signal input is selected from the group of applying electromagnetic radiation to the at least one solution, applying mechanical input to the at least one solution, applying vibratory input to the at least one solution, changing a magnetic field of the at least one solution, introducing a secondary solute to the at least one solution, and removing a substance from the at least one solution.

The various embodiments also provide methods of using an osmotically driven membrane process (ODMP) to separate a solvent and a solute in a feed solution, including providing the feed solution in a stream on a first side of a semi-permeable membrane, providing a draw solution stream that includes a gel on an opposite side of the semi-permeable membrane, in which an osmotic pressure gradient from the draw solution stream causes the solvent in the feed solution to pass through the semi-permeable membrane and to dilute the draw solution stream, and introducing a signal input to the diluted draw solution stream, in which the signal input enables reuse of the gel in the draw solution stream.

The accompanying drawings, which are incorporated herein and constitute part of this specification, illustrate exemplary embodiments of the invention, and together with the general description given above and the detailed description given below, serve to explain the features of the invention.

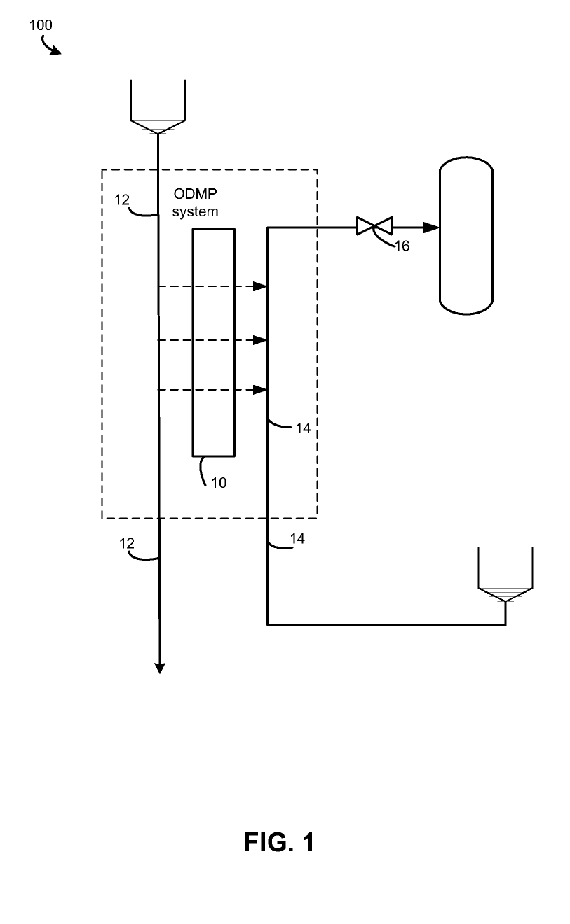

FIG. 1 is a schematic of a membrane separation system implementing an osmotically driven membrane process.

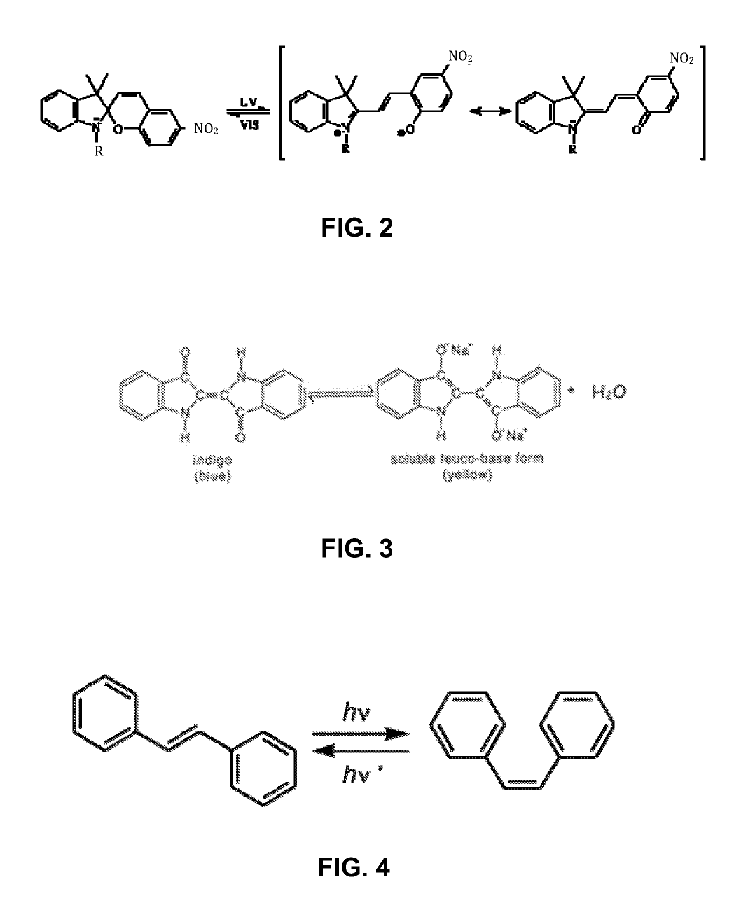

FIG. 2 is an illustration representing a conversion of insoluble form spiropyrans to soluble forms by inputting ultraviolet radiation.

FIG. 3 is an illustration representing the reduction of indigo to leuco-indigo.

FIG. 4 is an illustration representing an input effect driven by a signal responsive solute, according to an embodiment.

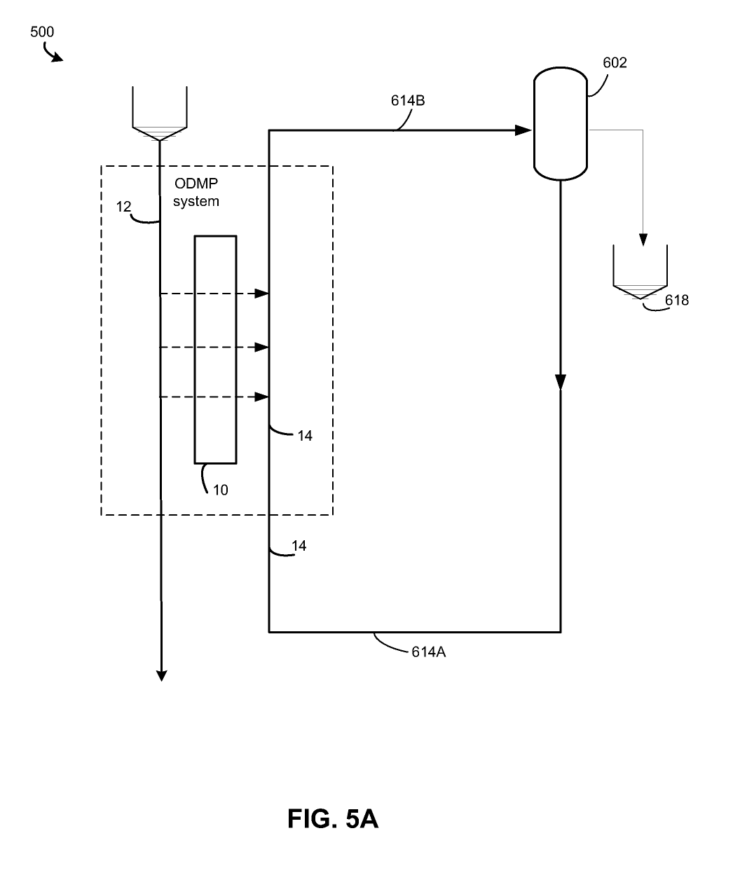

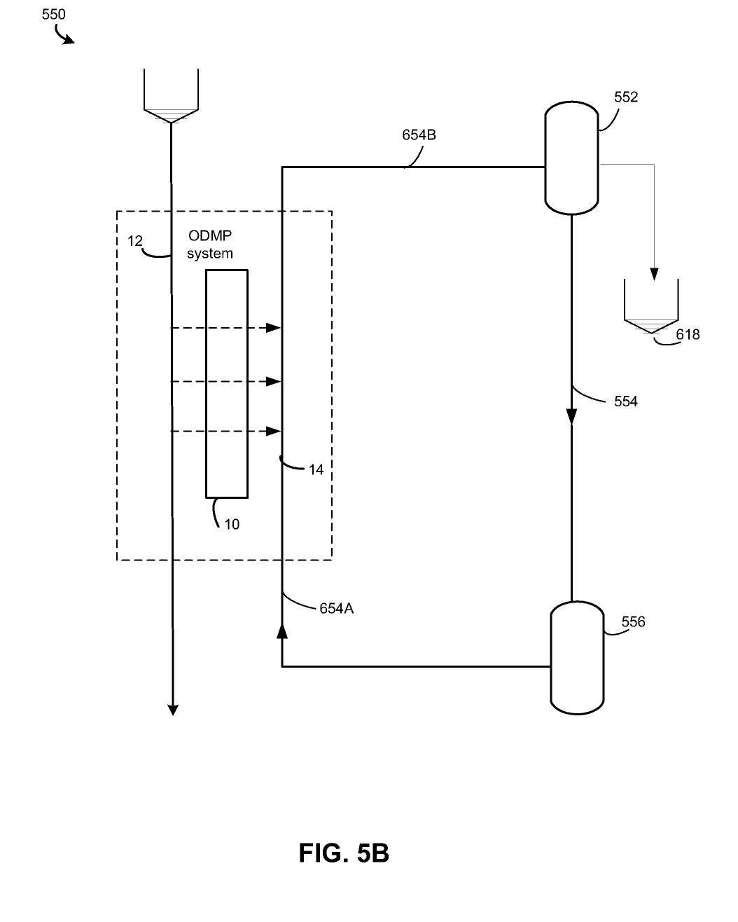

FIG. 5A is a schematic of an ODMP system that uses a signal responsive hydrogel draw solute to create osmotic pressure across a membrane according to an embodiment.

FIG. 5B is a schematic of an ODMP system in which a signal responsive polymer system converts between sol and gel states to create osmotic pressure across a membrane according to another embodiment.

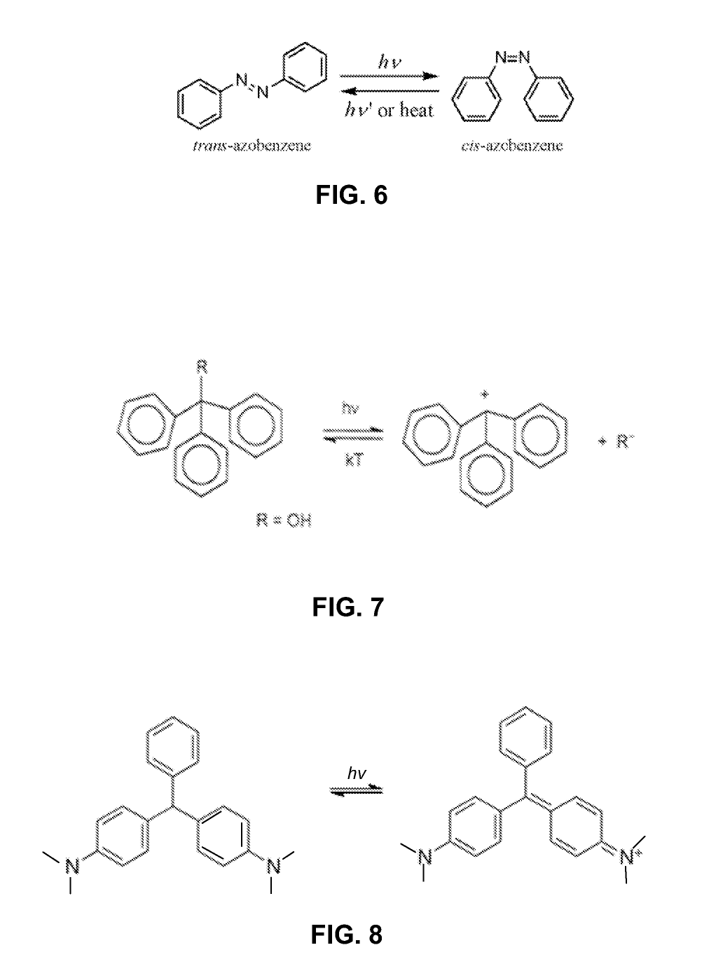

FIG. 6 is an illustration representing an input effect driven by a signal responsive composition that may be included in polymers of the polymer system shown in FIG. 5B, according to another embodiment.

FIG. 7 is an illustration representing an input effect driven by a signal responsive solute, according to another embodiment.

FIG. 8 is an illustration representing an input effect driven by a signal responsive solute, according to another embodiment.

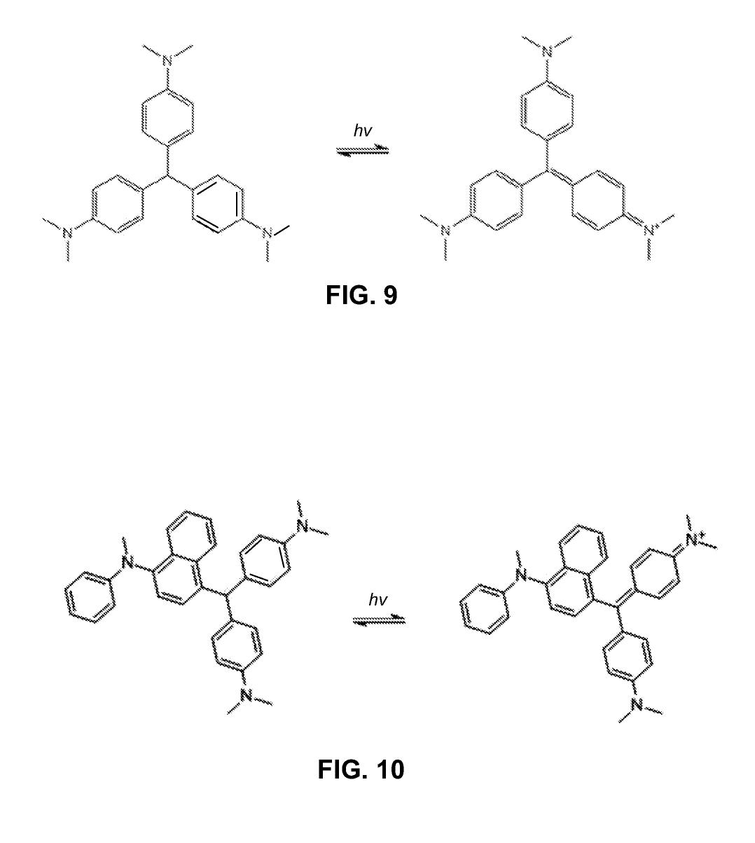

FIG. 9 is an illustration representing an input effect driven by a signal

FIG. 10 is an illustration representing an input effect driven by a signal responsive solute, according to another embodiment.

### DETAILED DESCRIPTION

The term “membrane separation process” is used to refer to processes that separate gaseous or liquid streams through a semi-permeable barrier in a membrane separation system.

The terms “osmotically driven membrane process,” “ODMP” and “ODMP system” are used interchangeably herein to refer generally to processes/systems that use a semi-permeable membrane to effect an osmotic separation of a fluid solvent, such as water, from dissolved solutes, discussed in further detail below. These terms may also be used interchangeably herein with the terms “membrane separation process,” but are provided as merely one example type of membrane separation.

As used herein, the terms “signal responsive,” “photoreactive,” “electroreactive,” and “thermoreactive” refer generally to materials in which measurable changes occur in response to energy input. Many such designations depicting the input and its measurable effects may be used, which may be referred generally to an “input-effect.”

As used herein, the term “photochromic” refers to materials in which exposure to ultraviolet or visible electromagnetic radiation causes a change in optical properties.

Recovery and re-concentration of draw solution solutes may be greatly enhanced by modifying solutes such that solubility can be reversibly controlled by low value energy inputs.

The various embodiments invention provide for use of signaling, by means of specific energy inputs targeted to interact with solutes in specific ways, to induce the change in solubility of solutes within a solution. Signaling may take the form, for example, of ultraviolet radiation; visible light; electromagnetic radiation outside of the UV/visible spectrum, such as infrared or microwave radiation; heat; electrical current; of a secondary solute. Mechanisms by which solubility may change in response to input signaling may include, for example, cross-linking or un-cross-linking within a molecule or polymer or between them, in ways that reduce solubility; change in conformation of a molecule or polymer, changing solubility characteristics; changes in charge distribution, such as the formation of a zwitterion; disassociation of a non-charged species into charged species; as well as other mechanisms for changing the number of species and/or their interactions with the solvent. The change in solubility of the solute is ideally reversible, but may use different signaling methods for each direction of transformation. The use of such solutes is contemplated in ODMPs and electrochemical processes such as RED, but additionally in other processes that benefit from controllable changes in solute solubility.

In addition to the solutes, materials, molecules, compounds, polymers, etc, described above, alternate forms may be used that include multiple chromaphores or other signal-reactive components within their structure, rather than the examples of single signal responsive components discussed. Mixtures of various forms of signal responsive solutes, or mixtures of such solutes with solutes that are not signal responsive, may be used together. In some cases, such mixing may involve cascading effects, such as when a signal induced changed in one solute causes signaling for other solutes, or changes in the solubility of solutes not otherwise responsive to signals.

The various embodiments may be used to recover draw solute in any of a number of osmotically driven membrane processes (ODMPs). Examples of such ODMPs may include forward osmosis (FO) and/or pressure enhanced osmosis (PEO) desalination or water treatment, pressure retarded osmosis (PRO) power generation, and direct osmotic concentration (DOC) of desired feed stream constituent. In some ODMPs for which the embodiment recovery systems may be used, a first solution (i.e., process or feed solution) may be seawater, brackish water, wastewater, contaminated water, a process stream, or other aqueous solution may be exposed to a first surface of the membrane. A second solution (i.e., a draw solution) may be prepared with an increased concentration of various solutes relative to that of the feed solution may be

In the various embodiments, the feed solution may be any solution containing solvent and one or more solutes for which separation, purification or other treatment is desired. Example applications for such treatment may include recovery of purified water for downstream use, removal of undesirable solutes from water, concentration and recovery of desired solutes, etc.

In some purification processes embodiments, the feed solution may be filtered and pre-treated in accordance with known techniques in order to remove solid and chemical wastes, biological contaminants, and otherwise prevent membrane fouling, prior to osmotic separation. The feed solution may be delivered to a forward osmosis membrane treatment system from a source module providing previously-stored feed solution, from an upstream unit operation such as industrial facility, or from any of a number of other sources, including a sea or an ocean. Example feed solutions that may be used in the various embodiments include, but are not limited to, aqueous solutions such as seawater, brine and other saline solutions, brackish water, mineralized water, industrial waste water, and product streams associated with high purity applications, such as those affiliated with the food and pharmaceutical industries.

The draw solution may generally be capable of generating osmotic pressure within an osmotically driven membrane system. The osmotic pressure may be used for a variety of purposes, including desalination, water treatment, solute concentration, power generation, and other applications. A wide variety of removable draw solution solutes may be used in the various embodiments, which may be signal responsive and/or may be coupled to signal responsive materials.

FIG. 1 illustrates an embodiment ODMP system 100, which may include any type of semi-permeable membrane 10 in which water flux is driven from a feed stream 12 to the draw solution stream 14 due to osmotic pressure difference across the membrane 10 (e.g., FO, PRO, PEO, DOC). For example, in a FO membrane system, the feed stream 12 is desalinated in that the water flux through the membrane 10 into the draw solution 14 effectively separates the feed water from its solutes, now concentrated flows from the feed stream 12, also leaving a concentrated product solute stream, which may be recovered as a target compound. In a PRO membrane system, like the FO and DOC membrane systems, the water flux from the feed stream 12 leaves a concentrated product solute stream. In the PRO system, the initial feed stream may be further substantially unpressurized and diluted. In all of these example ODMPs, the feed solution stream 12 is concentrated, and the draw solution stream 14 is diluted, by water flux through the membrane system 10. In the case of PRO, stream 14 will additionally be pressurized, and subsequently directed to pressure exchangers. While solutes from each stream are substantially rejected from passing the semi-permeable membrane, some amount of solutes from the feed stream may enter the draw solution stream, and solutes from the draw solution stream may enter the feed solution, to varying degrees, depending on the operating conditions of the system. Further, ions from each stream may also cross the membrane, without equal representation by their counter ions, so long as ions of the same charge cross the membrane in the opposite direction, a phenomenon known as membrane ion exchange. The diluted draw solution stream 14 may be collected at a first outlet 16 and undergo a further separation process. In some embodiments, purified water may be produced as a product from the solvent-enriched solution. In the various embodiments, draw solutes may be specifically selected, modified, or designed to optimize control and recover in an ODMP system.

A number of mechanisms for transforming a signal input of energy or information into a system can cause changes in solute-solvent relationships. These mechanisms may be used to change solute concentrations, and by this means, solution osmotic pressure, water activity, and/or electrochemical potential. Many of the mechanisms that may be used for this purpose may be considered to fall within the field of organic chemistry, but are not limited to them, as techniques using inorganic chemistry and biology are also available.

In various embodiments, the use of ultraviolet radiation and/or visible light, may be used, to cause materials to transform such signal energy inputs into changes in molecule and/or polymer conformation; distribution of charge across a molecule or conducting or semi-conducting materials, which may then effect one or more of the above effects; or the generation of reactive species, for example, oxygen radical species or electron donors, which may then effect one or more of the above effects. Other reactions to such energy inputs that may take place include the dissociation of non-charged species into charged ones, or the converse conversion of charged species into non-charged ones. These or similar changes may cause other changes in the characteristics of the solution, for example, the pH or redox potential of the solution. These and/or similar changes may also cause other solubility and/or solution effects that may be desirous for the purpose of the system in which these signal energy inputs are employed.

Similar effects on a solution may be achieved using energy signal inputs in the form of thermal energy input to change the temperature of the solution; electromagnetic energy inputs other than ultraviolet or visible light, such as infrared or microwave energy; vibratory or other mechanical energy inputs, such as ultrasonic energy; electrical current; changes in the electromagnetic field environment of the solution; as well as other external inputs that have the effect of causing a change in the concentration of solutes within a solution. The solvent may be aqueous or non-aqueous, as such effects occur across a range of solvents, and various combinations of solvent/solute interactions may be used to achieve the desired system (ODMP, electrochemical device, etc.) effect.

Examples of the types of solutes and materials that may respond to energy signal inputs include, but are not limited to, molecules, compounds, and polymers that may contain, for example: Inorganic materials such as various forms of titanium, platinum, barium, magnesium, silicates, oxides or hydrides of these or other inorganic materials (e.g., yttrium hydride, BaMgSiO₄, etc.); ion-exchanged inorganic materials; organic groups such as those containing pararosanilines, triarylmethanes, benzophenones, acetophenones, vinylbenzylthymines, vinylphenylcinnamates, anthrones, anthrone-like heterocycles, vinylbenzyluracils, anthraquinone, vinylcoumarins, vinylchalcones, N-acryloylamidopyridinium halides, diarylethenes, azobenzenes, dithienylethenes, furylfulgides, thiazenes, azines, dinitrobenzylpyridines, and/or the substituted derivatives thereof; and metal-organic complexes and frameworks.

Materials that may be used directly as solutes, without being a component of a polymer or engaging in cross-linking or other such reactions as are described above (many of which may also be used as components of other solute systems, such as polymers, in other embodiments), include those that are normally insoluble in polar solvents such as water, but upon exposure to various signals, change reversibly to being soluble in such solvents. With other signals, or in some cases, spontaneously with time, which may accelerated by some signals, these solutes change back to their insoluble forms. Examples of such solutes may include, but are not limited to: diarylethenes such as stilbene; triphenylmethanes such as triphenylcarbinol, trimethylmethane leuco-cyanides, malachite green (e.g., the chloride, oxalate, or carbinol base), crystal violet, victoria blue, brilliant blue (e.g., FD&C dye No. 1) indigo and indigo derivatives; pararosanilines such as pararosaniline methanol, chloride, or acetate; spiropyrans such as spiroxazines; benzo and napthopyrans; and azobenzenes. Many of these are normally described as, and are often used as, dyes or pigments.

In a converse solubility relationship to signaling, materials that may be used directly as solutes, (many of which may also be used as components of other solute systems, such as polymers), without being a component of a polymer or engaging in cross-linking or other such reactions as are described above include those that are normally soluble in polar solvents such as water, but upon exposure to various signals, change reversibly to being insoluble in such solvents. With other signals, or in some cases, spontaneously with time, which may accelerated by some signals, these solutes change back to their soluble forms. Examples of such solutes include, but are not limited to: dithienylethenes; furylfulgides; thiazines such as methylene blue; azines such as Pyronine B; and dinitrobenzylpyridines. Many of these are normally described as, and often used as, dyes or pigments.

In addition to the use of materials that are directly responsive to signal inputs, solvent effects. These may include, for example: moieties that confer solubility to organic molecules, polymers, etc. that may be modified by the action of signal responsive materials, such as salts of organic acids; ionic moieties; groups capable of ionic bonding; groups that provide pH or other buffering effects such as carbonates or other inorganic buffers; polymers, non-polymer molecules, or dendrimers that contain hydroxyl groups, carbonic acid groups, etc.; metal oxides; mixed inorganic frameworks; metal-organic materials; and the like. Modifications that may occur in such systems include, for example, cross linking such as dimerization; photo-ring expansion; or other reactions that cause solubility-related features of the materials to change their contribution to solubility. Such effects may be reversible, for example, by: exposure to wavelengths of light or radiation that break the types of crosslinking bonds formed in the preceding reactions; use of catalysts, such as enzymes, that may cause these bonds to break, either alone or with additional signaling; change in temperature of the solution that causes the reversal of the cross-linking or other solubility-changing reactions; as well as other signal-induced material changes that may be known to achieve these desired effects. Such characteristics could be used to transform the solutes from soluble to insoluble, or the reverse, as desired. Materials that have many of these desired characteristics include, for example, various photo-resists, as are used in fields such as lithography.

Another manner in which signal-responsive systems may be used to change the solubility of solutes includes species that capture or combine with other species to cause a reduction in total dissolved species in solution. These may include, for example, molecules that chelate or form ionic couples, or form non-charged species once they have combined with charged ions. Solutes of this type include, but are not limited to: triphenylmethane dyes; diarylethenes such as bis(crown) diarylethenes that complex with metal ions; signal responsive molecules that bind ions by virtue of changes to their charge distributions; caged reagents such as NP-gated EGTA (for example, salt or ester); or DMNP-EDTA. here include, but are not limited to: sensitizers (for example, free radical generators, or substances that change or expand the range of light wavelengths that may be used), oxygen, bleaches (e.g., NaHOCl, KCn, NaHSO₃, Zn and HCl, KOH, acidified thiourea, etc.) and/or other oxidizing agents (e.g., H₂SO₄). Other additives may improve reversible function (e.g., esters and soaps of carboxylic acids, and/or other buffers for byproducts of the reversible reactions). Buffers for changes in pH may also be used to maintain compatibility with membranes or other system components or solutes. In other cases, anti-oxidants may be used. Removal and exclusion of oxygen or other oxidizers from the solution may also be employed. Secondary separation processes to conserve these additives within the system may additionally be employed, including, but not limited to reverse osmosis (RO) and/or filtration (e.g., microfiltration, ultrafiltration or nanofiltration) used on the solvent stream after separation from the largely insoluble solutes.

In some embodiments, secondary solvents that are slightly miscible or largely immiscible in the primary solvent may also be used in conjunction with a primary solvent. In one embodiment, a solute may have an insoluble form in the primary solvent, which form may be soluble in the secondary solvent. In this manner, the solutes may be transferred between their primary-solvent-soluble and insoluble forms in a way that improves system function, for example, without the need to handle solid precipitates. In some cases, solutes may not form precipitates, but rather second immiscible liquid phases. In cases where more than one liquid phase is present, various means for separation may be employed in the system for separation of the second solvent or solutes liquid phase, such as by mechanical means such as the use of a hydrocyclone.

The secondary solvent is used to assist in the separation of the solute and the first solvent once the solute undergoes a signal-induced change in solubility. For example, a compound (e.g., draw solute) may be water soluble until it is exposed to ultraviolet light, and then become water insoluble, but soluble in the secondary solvent. The secondary solvent allows for easier handling and removal for reuse of the changed containing the dissolved solute can be separated using liquid/liquid separation techniques, rather than the liquid/solid separation techniques for the precipitated solute in water of the other embodiments (e.g., where the solute becomes insoluble, precipitates, and collects as a solid, which is then separated mechanically for reuse).

Another manner in which signal responsive systems may be used in membrane separation includes the use of hydrogels. In some embodiments, hydrogels made of polymers containing signal-responsive components may be used as a draw solution, and may change from a solvent-absorbing state (i.e., “diluted” or swelled with solvent, for example, water) to a dewatered state upon a signal input. A dewatered hydrogel may be used, for example, to perform the function of a draw solution (i.e., to induce the flow of solvent across a semi-permeable membrane from a feed solution). Once the dewatered hydrogel has absorbed a sufficient amount of solvent to be converted to a swelled hydrogel, the hydrogel may be removed from the ODMP system (i.e., away from the membrane) and subjected to a signal that causes it to transform to the dewatered state, thereby releasing much of the solvent (e.g., water) or allowing for its secondary removal. The dewatered hydrogel may then be used to again induce solvent flow across the membrane in the ODMP system. This cycle may be continued by use of alternating signals to the system.

Any combination of the above materials and methods to achieve the goals of the ODMP, electrochemical, or other solute controllable system, may also be employed. These combinations may have synergistic, desirably antagonistic, or simply accumulative effects. In many cases, signals may be interchangeable, through the use of additives that allow for their inter-conversion. In some embodiments, various phosphors or dyes allow the conversion of ultraviolet radiation to visible light, and vice-versa. In such embodiments, the various phosphors or dyes may be draw solutes in a draw solution, or may be primary solution modifiers that change conditions of the solution (e.g., pH, temperature, etc.) which affect solubility of other substances in a draw solution (i.e., draw solutes). In some embodiments, the use of other materials such as titanium dioxide (TiO₂) may allow for the creation of free radicals as a result of chemical reactions through oxidation or electron transfer. In another embodiment, materials such as carbon particles may be included that allow for the conversion of various wavelengths of light into heat, and materials such as chromaphores may be included to allow for the conversion of light into electrical current. By use of such materials in combination, electrical signal responsive solutes may be signaled, for example, with exposure to ultraviolet radiation and/or ultraviolet radiation responsive solutes may be signaled with input electrical current. Various other embodiments may include the use of other materials, alone or in combination.

In an embodiment membrane separation system, a draw solution may contain signal responsive solutes that are normally soluble in water, but become insoluble from exposure to ultraviolet radiation. In these embodiments, soluble form solutes may be used to create a concentrated draw solution, which may become diluted through normal operation of the membrane separation system. Draw solutes from the diluted draw solution may be recycled through exposure to ultraviolet radiation. In particular, such exposure may cause the signal responsive solutes to undergo a change in conformation and/or charge distribution thereby significantly reducing their solubility. In some examples, the insoluble form solutes may be re-concentrated by removing the largely solute free solvent and exposing the solutes to heat, which may accelerate a spontaneous reversion to their soluble form. A re-concentrated solution may then re-used within the process. One example signal responsive solute in this embodiment may be methylene blue, in the presence of Zn and HCl. The soluble form solute methylene blue may have a solubility of up to around 0.12 M. Another example group of signal responsive solutes that may be used in this embodiment is Pyronine B, or other azine dyes. Such compounds may be photochromic in water upon exposure to ultraviolet radiation in the presence of Zn and HCl.

In a similar embodiment, soluble form solutes may be used to create a concentrated draw solution, which may become diluted through normal operation of the membrane separation system, as discussed in the previous embodiment. Draw solutes from the diluted draw solution may be recycled through exposure to ultraviolet solute molecules. This property may cause the soluble form solutes to become insoluble form solutes upon exposure to ultraviolet radiation. Such solutes may be recycled in a re-concentrated form, by removing the largely solute free solvent, and exposing the insoluble-form solutes to visible light, in the presence of a reduced quantity of solvent, thereby breaking the cross links and re-generating the solute. The re-concentrated solution may then re-used within the process. One example of a signal responsive solute that may be used in this embodiment is a photoresist.

In another embodiment membrane separation system, a draw solution may contain signal responsive solutes that are normally insoluble in water, and become soluble from exposure to ultraviolet radiation in the presence of solvent. In this embodiment, such exposure to ultraviolet radiation may create a concentrated solution, which may become diluted through normal operation of the membrane separation system. The diluted solution may be heated and/or exposed to visible light in order to accelerate a spontaneous reversion to the insoluble form. The insoluble form solutes may then be recycled and re-concentrated by removing the largely solute free solvent, and exposing the insoluble form solutes, in the presence of solvent, to ultraviolet radiation, thereby causing them to convert again to their soluble form. One example signal responsive solute of this embodiment may be malachite green oxalate, which, in the soluble form of the solute, may have a solubility of up to around 0.33 M. Another example signal responsive solute of this embodiment may be one or more of the group of spiropyrans (i.e., spirobenzo- pyranindolines). As shown in FIG. 2, insoluble form solutes of this class (e.g., 6-nitrobenzoindolinopyran) may be a closed ring, colorless structure, while soluble form solutes that may be created upon exposure to ultraviolet radiation (e.g., merocyanine) may be open ring, colored structures. Thus, the change in solubility from insoluble to soluble form solutes may also be visually indicated by a change from a colored to colorless material. In this example, the quantum yield for the conversion of 6-nitrobenzo-indolinopyran to merocyanine may be 10-50%. Further, the reverse conversion of merocyanine to 6-nitrobenzoindolinopyran may occur upon exposure to visible or thermal radiation, and may allow for this solute to be used in up to instead of or in addition to spiropyrans may include spiroxazines.

In another embodiment membrane separation system, draw solution solutes may include signal responsive molecules that are normally insoluble in a solvent, but which become soluble in the solvent by reduction. Reduction may be, for example, chemical, biological, or electrochemical (e.g., electrocatalytic hydrogenation or via a mediator electron transport species). In an example, reduction may be initiated through ultraviolet radiation using an appropriate photocatalyst (e.g., semiconductor nanoparticles). In this manner, a concentrated draw solution may be formed for use, for example, in an ODMP system. The draw solution may become diluted through normal operation of the ODMP system due to solvent passing from the feed solution through the membrane. The diluted draw solution may be exposed to an oxidant, such as atmospheric oxygen, which may cause the draw solution solute to become insoluble and to precipitate out of solution. The largely solute free solvent may then removed and the solute may be re-concentrated once again for reuse through reduction. An example signal responsive molecule for use in this embodiment may include indigo, which is insoluble in water, and which may be reduced to the soluble compound leuco-indigo (“white” indigo), which is soluble. An example of this reversible reaction is shown in FIG. 3. Various reducing agents may be used to reduce indigo to leuco-indigo, such as an alkali solution of sodium dithionite. In another example, reduction of indigo may occur upon exposure to ultraviolet light in the presence of a photocatalyst, such as platinum-doped titanium dioxide, which may lead to the solvent water acting as a reducing agent for indigo to produce leuco-indigo and O₂. In another example of this embodiment, indigo may be reduced through use of a mediator (i.e., a carrier), such as THAQ, which through conversion to DHAQ may transport electrons from a cathode to the indigo, thereby producing leuco-indigo.

In another embodiment membrane separation system, a draw solution may include draw solutes that contain an insoluble indigo compound and an insoluble photochromic solute such as triphenylcarbinol. In this embodiment, exposure to ultraviolet radiation may cause photo-oxidation of triphenylcarbinol, which converts that may reduce the indigo to soluble leuco-indigo. In this manner, the input of ultraviolet radiation causes both triphenylcarbinol and indigo to become soluble. Once a concentrated solution is diluted by normal operation of an ODMP or electrochemical system, the solutes may be reverted to their insoluble forms by exposure to atmospheric oxygen or other oxidant and heat, thereby allowing for the removal of largely solute free solvent. In an example, the solutes may be reused in a continuous process by again exposing them to ultraviolet radiation and repeating the cycle.

In another embodiment, solute recovery in a membrane separation system may be improved by using a draw solution that contains solutes composed of charged signal responsive molecules and metal ions. In an example ODMP system, the draw solution may become diluted from solvent that passes through the membrane from the feed solution. Following separation, the diluted draw solution may be exposed to visible light, thereby causing the solutes to become insoluble and to form complexes with the metal ions. In this manner, the total number of dissolved species may be substantially reduced. The largely solute-free or solute reduced solvent may be removed, and optionally, a secondary separation process may be used to recover any additional draw solution solutes from the solvent. The signal responsive draw solutes may be re-concentrated from the insoluble complexes by exposure to ultraviolet light in the presence of a small amount of solvent, causing separation into the signal responsive molecule and metal ion. In some cases, the re-concentrated signal responsive solutes may be recombined with the solutes recovered by the secondary separation process, which may be reused in the ODMP or electrochemical system. One example class of signal responsive molecules that may be used in this embodiment is bis(crown) diarylethenes, which may be used in conjunction with potassium ions and/or rubidium ions as the metal ions with which complexes may be formed. In other examples in which different diarylethenes are used in the draw solution, the metal ions may include calcium, sodium, silver, and/or cesium ions.

Other diarylethenes may also be used as signal responsive molecules in various embodiments, for example, cis-Stilbene (1,2-diphenylethene). In particular, exposure cause conversion to trans-Stilbene, which is insoluble in water and colorless. Such reaction, shown in FIG. 4, is reversible with exposure to ultraviolet light. Therefore, the change in solubility may be indicated by a change in color. That is, the solute may lose color, upon becoming insoluble, and may regain color in the re-concentration phase.

In an embodiment ODMP system, a signal responsive hydrogel may be used to perform the functions of a draw solution (i.e., to cause osmotic pressure for the flux of water through the semi-permeable membrane). A hydrogel is a gel in which the liquid component is water. Preferably, the hydrogel is a polymer hydrogel having a network of polymer chains that are hydrophilic, in which water is the dispersion medium.

The hydrogel may comprise a pure polymer hydrogel or a composite polymer hydrogel in which the polymer network matrix also contains a hydrophilic inclusion material, such as hydrophilic carbon particulars. In particular, a signal responsive hydrogel may include various polymers that undergo network collapse and swelling.

FIG. 5A illustrates an example ODMP system 500, which may have many of the same elements as the ODMP system 100 described above with respect to FIG. 1, but which uses a signal responsive hydrogel. In conduit 614A, a collapsed network hydrogel (i.e., a dewatered hydrogel) is provided into an ODMP system, such as a FO system. The hydrogel in conduit 614A is provided as the “draw solution stream” to conduit 14 of the ODMP system on one side of the membrane 10. A feed stream (e.g., impure water) in conduit 12 is provided into the system 500 on the opposite side of the membrane 10. This causes water flux across the semi-permeable membrane 10 from the feed solution in conduit 12 through the membrane 10 into the hydrogel in conduit 14 containing “draw solution” during normal operation of the ODMP. The water flux may cause the dewatered hydrogel in conduit 614A to become a “diluted” or swelled hydrogel in conduit 614B (i.e., in which the polymer network is swelled with water).

The diluted draw “solution” containing the swelled hydrogel is then moved away from the membrane 10 in the ODMP system and provided via conduit 614B to a dewatering step in chamber 602. Chamber 602 is located separately from the signal input, for example, exposure to radiation (e.g., ultraviolet radiation, visible light, infrared radiation, etc.). The source of radiation in the dewatering step may be sunlight and/or an artificial source. The hydrogel exiting chamber 602 in conduit 614A is dewatered hydrogel, and the water separated from hydrogel 614B in the dewatering step may be removed from chamber 602 and stored or used as purified product water 618. The dewatered hydrogel in conduit 614A is then reused in the ODMP process in the “draw solution.”

The dewatered and swelled hydrogel is part of the flowing draw “solution” stream that flows past the membrane 10. Thus, the hydrogel may be in a particle form or another suitable form to allow it to flow in the loop through conduits 614A, 14 and 614B with the draw stream. Preferably, the hydrogel is not attached to the membrane 10.

In another embodiment ODMP system, polymer systems that undergo signal responsive transitions between sol and gel states may create the feed stream solvent flux (e.g., water flux) across the membrane. For example, polymer systems may contain signal-responsive groups or chains to allow conversion from a solvent-absorbed gel state (e.g., a swelled gel state) to a sol state in which the absorbed solvent is released, upon signal input. Further, the sol may be converted back into a dewatered gel state upon a second signal input, which may then reused in the ODMP to again induce solvent flux across the membrane. This cycle may be continued by use of alternating signals to the system.

FIG. 5B illustrates an example ODMP system 550, which may have many of the same elements as the ODMP systems 100 and 500 described above with respect to FIGS. 5A and 5B, respectively, but which uses a signal responsive reversible sol-gel polymer system. A draw “solution” stream containing a draw “solute” in a dewatered gel state may be provided into an ODMP system, such as a FO system, via conduit 654A. The draw “solution” stream is provided from conduit 654A into conduit 14 of the ODMP system on one side of the membrane 10. The feed stream (e.g., impure water) in conduit 12 is provided into the system 550 on the opposite side of the membrane 10. in conduit 12 through the membrane 10 into the draw “solution” stream containing the dewatered gel during normal operation of the ODMP. The water flux may cause the dewatered gel in conduit 14 to absorb water, thereby becoming a swelled gel (e.g., a swelled gel state polymer).

The diluted draw “solution” containing the swelled gel is then moved away from the membrane 10 in the ODMP system and provided via conduit 654B to gel-sol conversion step in gel-to-sol conversion chamber 552. Chamber 552 is located separately from the membrane 10 in the ODMP system.

In the gel-to-sol conversion chamber 552, a signal input causes the swelled gel to be converted to a sol state, causing separation of the absorbed solvent from the swelled gel. The signal input in the gel-to-sol conversion may involve, for example, exposure to radiation (e.g., ultraviolet radiation). The source of radiation for the gel-to-sol conversion may be sunlight and/or an artificial source. The water or other solvent released from the gel may be removed from chamber 552 and stored or used as purified product water 618.

The sol particles exit the gel-to-sol conversion chamber 552 via conduit 554 and enter a sol-to-gel conversion chamber 556. If desired, chambers 552 and 556 may comprise a single housing having two regions 552 and 556 connected by a conduit passage 554, or the chambers 552 and 556 may comprise separate housings connected by a pipe 554. In the sol-to-gel conversion, a second signal input (e.g., exposure to visible light or infrared radiation) may cause the sol to be converted back into a dewatered gel. The dewatered gel may exit the sol-to-gel conversion chamber 556 via conduit 654A, and may be may be provided back into the ODMP system to be reused.

Thus, in summary, the process shown in FIG. 5B includes providing the draw solution in which at least one solute comprises a dewatered gel to the ODMP system in which dilution of the draw solution stream changes the dewatered gel into a swelled gel. The process also includes introducing a first signal input (e.g., UV radiation) to the swelled gel to convert the swelled gel to a sol in chamber 552 to release a solvent that visible light) to the sol in chamber 556 to convert the sol to the dewatered gel which is again provided to the ODMP system.

The dewatered gel and the swelled gel include crosslinks between functional chemical groups. The conversion of the swelled gel to the sol breaks the crosslinks, and the conversion of the sol to the dewatered gel creates the crosslinks. The dewatered and swelled gel are part of the flowing draw “solution” stream that flows past the membrane 10. Thus, the gel may be in a particle form or another suitable form to allow it to flow in the loop through conduits 654A, 14 and 654B with the draw stream. Preferably, the gel is not attached to the membrane 10.

Example signal responsive polymer system in this embodiment may include dextran polymers containing trans- configurations of azobenzene functional groups. As shown in FIG. 6, such trans- azobenzene functional groups form cross crosslinks with dextran polymers, but upon exposure to ultraviolet radiation convert to their cis-configurations. This conversion breaks the cross links of these groups, causing the gel state to transform into a sol state. In some cases, a secondary separation process, such as filtration, coagulation and settling, etc., may be used to separate the non-solvent constituents of the sol from the solvent. Exposure of the reduced solvent sol to visible light and/or heat may cause reconversion from cis to trans form of the azobenzene functional groups, which may cause the gel to reform, allowing for its reuse.

In another embodiment membrane separation system, the draw solution solute may include any of a number of triphenylmethane dyes, or dyes with similar properties.

In some embodiment membrane separation systems, a draw solution may include photoresponsive draw solutes that undergo a change in solubility and also cause change to the solution environment, thereby causing changes in other properties. Such change in other properties may be, for example, a change in the solubility of other solutes, a change in the pH, etc. For example, a draw solution may contain photoresponsive solutes that are normally insoluble in water, along with other solutes that are normally insoluble at the pH of the photoresponsive solutes in water. Such amount of water, thereby causing the photoresponsive solutes to become soluble and causing a change in the pH of the solution. As a result, the other solutes may become soluble, thereby creating a concentrated draw solution for use in a membrane separation process, such as in an ODMP or electrochemical system, and in particular in a PRO or RED system. Upon dilution of the concentrated draw solution by normal operation of the membrane (e.g., by water flux in the case of PRO, or by ion transport in the case of RED), the diluted solution may be exposed to heat (from infrared wavelength absorption) and/or visible light. In this manner, the photo-responsive solutes may again become insoluble, thereby causing the pH to drop and the other solutes to become insoluble, which may result in a largely solute free solvent. The resulting solvent may be removed and reused in the process (as dilute working fluid in the PRO process, or the dilute stream in the RED process). The remaining insoluble form solutes may be exposed again to ultraviolet light in the presence of a small amount of solvent in order to re-concentrate an initial draw solution. In this manner, sunlight may be converted to electrical energy by means other than photovoltaic or concentrated solar thermal power production. In the case of several solutes quantum yields for photo-responsiveness may be on the order of 0.5-1, depending on the solvent system. Given that the change in solubility of the photo-responsive molecule may cause cascading secondary changes in solubility of other solutes, an effective quantum yield of the process could exceed unity. For example, if the PRO or RED process employed is equally efficient in transforming differences in salinity into power, the overall process may be highly efficient in converting solar energy into electricity.

An example draw solution solute according to this embodiment may include triphenylcarbinol (also called triphenylmethanol) and one or more pH-responsive dye compounds. As shown in FIG. 7, triphenylcarbinol is insoluble in water, yet may disassociate into a soluble triphenylmethanol cation and a hydroxide anion upon exposure to ultraviolet radiation. Further, due to increase in the concentration of hydroxide ions, the pH of the solution may increase, which may cause the optional pH indicator dye to change color. Thus, the use of a pH-responsive dye enables visibility of the solubility change. causes a change in the solubility of another solute, a signal responsive solute may include an insoluble form solute, malachite green carbinol base, and an insoluble form of FD&C Red no. 3 dye (i.e., at pH less than 4). Such insoluble materials may be exposed to ultraviolet radiation, which may photoionize the malachite green carbinol, thereby generating a soluble malachite green cation and a hydroxide ion in solution. Due to the hydroxide ions produced, the pH of the solution may be raised, which may further cause the FD&C Red no. 3 dye to become soluble. The process may be carried out in a small quantity of solvent, thereby resulting in a concentrated solution that may be used in an ODMP or electrochemical process. The draw solution may become diluted through normal operation of the membrane separation process (e.g., solvent flow from the feed solution passing through the membrane), and the diluted draw solution may be exposed to heat. In some embodiments, the exposure to heat may also involve use of a catalyst or bleaching agent. The heat may cause the malachite green cation to convert back to the insoluble form, i.e., malachite green carbinol base, thereby reducing the pH of the solution. The reduced pH may thereafter cause the FD&C Red no. 3 dye to convert back to its insoluble form, thereby resulting in a largely solute free solvent. A portion of the solvent may be removed, and the insoluble-form solute with some solvent may be exposed again to ultraviolet light to re-concentrate the initial draw solution for reuse in the membrane separation system.

In another embodiment involving photo-oxidation, a draw solution solute may include leuco-malachite green, which is only slightly soluble in water. Upon exposure to ultraviolet radiation, the leuco-malachite green is oxidized to a malachite green cation, shown in FIG. 8, which is very soluble in water. This conversion may provide a high quantum yield (e.g., around 0.91). Additionally or alternatively, malachite green cation, which may be provided in the form of a salt such as malachite green chloride or malachite green oxalate, may be converted to leuco-malachite green by exposure to heat. Alternative compounds that may be used instead of leuco-malachite green include leuco-crystal violet and leuco Victoria Blue BGO. Similar to leuco-malachite green, these compounds may be interconvertible with their soluble cations, Crystal Violet and Victoria Blue BO, as shown in FIGS. 9 and 10, respectively. In another example, the pure ethanol as the solvent instead of water, thereby increasing the quantum yield for the conversion of the photoresponsive dye may be increased. The membrane in this embodiment may be non-reactive in a pure ethanol solution, such as a nanofiltration (NF) membrane or an ultrafiltration (UF) membrane.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the steps as a sequential process, many of the steps can be performed in parallel or concurrently.

Any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of controlling a solubility of a solute in a membrane separation process, comprising:
introducing a signal input to at least one solution used in the membrane separation process, wherein the signal input changes the solubility of at least one solute in the at least one solution;
wherein introducing the signal input is selected from the group of:
applying electromagnetic radiation to the at least one solution, applying mechanical input to the at least one solution, applying vibratory input to the at least one solution, changing a magnetic field of the at least one solution, introducing a secondary solute to the at least one solution, and removing a substance from the at least one solution.

2. The method of claim 1, wherein the membrane separation process is an electrochemical process or an osmotically driven membrane process (ODMP), wherein the ODMP comprises one of forward osmosis (FO), pressure retarded osmosis (PRO), and direct osmotic concentration (DOC).

3. The method of claim 2, wherein the electrochemical process comprises a reverse electrodialysis (RED) process.

4. The method of claim 1, further comprising introducing one or more additive comprising a sensitizer, bleach, buffer, oxidizer, or anti-oxidant to the at least one solution, wherein the one or more additive enhances the change in solubility.

5. The method of claim 4, further comprising:
separating insoluble solutes from a solvent stream in the at least one solution after the at least one solution has been used in the membrane separation process; and
performing one or more secondary separation process to conserve at least one of the additive and a remaining soluble form solute for reuse in the membrane separation process.

6. The method of claim 5, wherein the at least one secondary separation process comprises a pressurized membrane separation process selected from the group of microfiltration, ultrafiltration, nanofiltration, and reverse osmosis.

7. The method of claim 1, wherein:
the at least one solution comprises at least one primary solvent and at least one secondary solvent;
the at least one secondary solvent has low miscibility in the primary solvent;
the at least one solute is insoluble in the at least one primary solvent; and
the at least one solute is soluble in the at least one secondary solvent.

8. The method of claim 7, further comprising separating the at least one primary solvent and the at least one secondary solvent, wherein separation is performed by skimming or hydrocyclone separation.

9. The method of claim 1, wherein the change in solubility of the at least one solute comprises conversion of a soluble form of the at least one solute to an insoluble form of the at least one solute.

10. The method of claim 9, wherein the insoluble form of the at least one solute forms a precipitate, wherein the precipitate is reused within the membrane separation process through one or more solid-handling processes.

11. The method of claim 9, wherein molecules of the at least one solute undergo conformational changes that alter interaction between soluble portions of the at least one solute and at least one solvent of the at least one solution.

12. The method of claim 9, wherein molecules of the at least one solute undergo changes in charge distribution, wherein interactions between at least one solvent and molecules of the at least one solute in the at least one solution are changed.

13. The method of claim 9, wherein:
introducing the signal input to the at least one solution comprises exposing the at least one solution to ultraviolet radiation; and
the at least one solute is selected from the group of dithienylethenes, furylfulgides, thiazines, azines, and dinitrobenzylpyridines.

14. The method of claim 9, wherein conversion of the at least one solute comprise a chemical reaction that causes cross linking among or between portions of the at least one solute.

15. The method of claim 14, wherein the at least one solute comprises compositions containing signal responsive groups selected from the group of:
titanium, platinum, barium, magnesium, silicate, yttrium, inorganic oxide or inorganic hydride;
ion-exchanged inorganic material;
polymer material;
organic group comprising pararosanilines, triarylmethanes, benzophenones, acetophenones, vinylbenzylthymines, vinylphenylcinnamates, anthrone, anthrone-like heterocycles, vinylbenzyluracils, anthraquinone, vinylcoumarins, vinylchalcones, N-acryloylamidopyridinium halides, diarylethenes, triphenylmethanes, spiropyrans, spiroxazines, benzopyrans, napthopyrans, azobenzenes, dithienylethenes, furylfulgides, thiazenes, azines, dinitrobenzylpyridines, and/or substituted derivatives thereof; or metal-organic complex or frameworks.

16. The method of claim 1, wherein a solvent of the at least one solution comprises water.

17. The method of claim 1, wherein a solvent of the at least one solution comprises a non-aqueous solvent.

18. The method of claim 1, wherein the change in solubility of the at least one solute comprises conversion of an insoluble form of the at least one solute to a soluble form of the at least one solute.

19. The method of claim 18, wherein molecules of the at least one solute undergo a chemical reaction that removes cross linking among and between portions of the molecules of the least one solute.

20. The method of claim 19, wherein the at least one solute comprises compositions containing signal responsive groups selected from the group of:
titanium, platinum, barium, magnesium, silicate, yttrium, inorganic oxide or inorganic hydride;
ion-exchanged inorganic material;
polymer material;
organic group comprising pararosanilines, triarylmethanes, benzophenones, acetophenones, vinylbenzylthymines, vinylphenylcinnamates, anthrone, anthrone-like heterocycles, vinylbenzyluracils, anthraquinone, vinylcoumarins, vinylchalcones, N-acryloylamidopyridinium halides, diarylethenes, triphenylmethanes, spiropyrans, spiroxazines, benzopyrans, napthopyrans, azobenzenes, dithienylethenes, furylfulgides, thiazenes, azines, dinitrobenzylpyridines, and/or substituted derivatives thereof; or
metal-organic complexes or frameworks.

21. The method of claim 18, wherein molecules of the at least one solute solutes undergo conformational changes that change interaction between soluble portions of the at least one solute and at least one solvent in the at least one solution.

22. The method of claim 18, wherein molecules of the at least one solute undergo changes in charge distribution, wherein interactions between at least one solvent and molecules of the at least one solute in the at least one solution are changed.

23. The method of claim 18, wherein the at least one solute is selected from the group of:
diarylethenes, triphenylmethanes, indigo, indigo derivatives, pararosanilines, spiropyrans, spriroxazines, benzopyrans, napthopyrans, and azobenzenes.

24. The method of claim 1, wherein the at least one solute comprises two or more solutes, wherein the signal input causes molecules of the two or more solutes to interact such that a total number of individual solute species is reduced in the at least one solution.

25. The method of claim 24, wherein the two or more solutes include a photo-responsive solute and a second solute, and wherein molecules of the photo-responsive solute and the second solute interact by undergoing complexation.

26. The method of claim 24, wherein at least one of the two or more solutes is selected from the group of triphenylmethane dyes, diarylethenes, NP-caged EGTA, and DMNP-EDTA.

27. The method of claim 1, wherein the signal input causes molecules of the at least one solute to dissociate such that a total number of individual solute species is increased.

28. The method of claim 27, wherein the at least one solute is selected form the group of triphenylmethane dyes, diarylethenes, NP-caged EGTA, and DMNP-EDTA.

29. The method of claim 1, wherein the change in the solubility of the at least one solute causes a secondary change in the at least one solution, and wherein the secondary change causes a change in the solubility of at least one other solute in the at least one solution.

30. The method of claim 29, wherein the secondary change in the at least one solution comprises one of a change in pH, change in redox potential, change in temperature of the at least one solution, and change in emittance of a secondary signal.

31. The method of claim 1, further comprising:
prior to introducing the signal input, performing the step of:
creating a concentrated draw solution using a soluble form of the at least one solute, wherein the concentrated draw solution becomes diluted with solvent drawn across a semi-permeable membrane,
wherein the change in solubility of at least one solute in the at least one solution comprises conversion from the soluble form to an insoluble form of the at least one solute.

32. The method of claim 31, wherein the at least one solute comprises a dye.

33. The method of claim 32, wherein the insoluble form of the at least one solute comprises leuco-malachite green, and wherein the soluble form of the at least one solute comprises malachite green oxalate.

34. The method of claim 32, wherein the introducing the signal input to at least one solution used in the membrane separation process comprises exposing the diluted draw solution to electromagnetic radiation.

35. The method of claim 34, exposing the diluted draw solution to electromagnetic radiation comprises exposing the diluted draw solution to ultraviolet radiation.

36. The method of claim 31, further comprising, after the signal input changes the solubility of the at least one solute:
separating the insoluble form of the at least one solute from a solvent in the diluted draw solution; and
re-creating the concentrated draw solution by exposing the removed insoluble form of the at least one solute to heat in the presence of the solvent.

37. The method of claim 1, further comprising:
prior to introducing the signal input, performing the steps of:
providing a draw solution into an osmotically driven membrane process, wherein a draw solute in the draw solution comprises a soluble dye; and
diluting the draw solution with solvent from a feed stream;
introducing the signal input to the at least one solution by exposing the soluble dye to radiation, wherein the soluble dye becomes insoluble;
separating the insoluble dye from the solvent;
exposing at least some of the insoluble dye to the solvent; and
re-concentrating the draw solution by converting the insoluble dye back to the soluble dye.

38. The method of claim 1, further comprising removing oxidants from the at least one solution to prevent or reduce interference in a desired reaction initiated by the signal input.

39. A method of using an osmotically driven membrane process (ODMP) to separate a solvent and a solute in a feed solution, comprising:
providing the feed solution in a stream on a first side of a semi-permeable membrane;
providing a draw solution stream including a gel on an opposite side of the semi-permeable membrane, wherein an osmotic pressure gradient from the draw solution stream causes the solvent in the feed solution to pass through the semi-permeable membrane and to dilute the draw solution stream; and
introducing a signal input to the diluted draw solution stream, wherein the signal input enables reuse of the gel in the draw solution stream.

40. The method of claim 39, wherein:
providing the draw solution stream including the gel comprises providing the draw solution in which at least one solute comprises a dewatered hydrogel, wherein dilution of the draw solution stream changes the dewatered hydrogel into a swelled hydrogel; and
introducing the signal input to the draw solution stream causes separation of solvent from the swelled hydrogel, wherein the swelled hydrogel changes back to the dewatered hydrogel.

41. The method of claim 40, wherein introducing the signal input to the draw solution stream comprises exposing the swelled hydrogel to electromagnetic radiation.

42. The method of claim 39, wherein:
providing the draw solution stream including the gel comprises providing the draw solution in which at least one solute comprises a dewatered gel, wherein dilution of the draw solution stream changes the dewatered gel into a swelled gel; and
introducing the signal input to the draw solution comprises:
introducing a first signal input to the swelled gel to convert the swelled gel to a sol to release a solvent that was contained in the swelled gel; and
introducing a second signal input to the sol to convert the sol to the dewatered gel.

43. The method of claim 42, wherein the dewatered gel and the swelled gel include crosslinks between functional chemical groups, and wherein conversion of the swelled gel to the sol breaks the crosslinks.

44. The method of claim 42, wherein:
introducing the first signal input comprises exposing the swelled gel to ultraviolet radiation; and
introducing the second signal input comprises exposing the sol to heat or visible light.
